(19) United States
(12) Patent Application Publication
(10) Pub. No.: US 2024/0100992 A1
(43) Pub. Date: Mar. 28, 2024

(54) VEHICULAR CONTROL SYSTEM WITH BATTERY FAILSAFE FOR DRIVER HANDOVER PROCESS

(71) Applicant: Magna Electronics Inc., Auburn Hills, MI (US)

(72) Inventors: Suresh Boddi, New Hudson, MI (US); Helmut A. H. Wodrich, Clarkston, MI (US)

(21) Appl. No.: 18/474,570

(22) Filed: Sep. 26, 2023

Related U.S. Application Data
(60) Provisional application No. 63/377,391, filed on Sep. 28, 2022.

(51) Int. Cl. B60L 58/16; B60L 3/00; B60L 50/62; B60L 58/18

(52) U.S. Cl. CPC B60L 58/16; B60L 3/0046; B60L 50/62; B60L 58/18; B60L 2210/44; B60L 2250/16

(57) ABSTRACT

A vehicular control system includes an electric motor operable to, when powered, drive one or more wheels of a vehicle, a primary battery operable to provide electric power to the electric motor, and a backup battery operable to provide electric power to the electric motor. When a switch is operating in a first state, the primary battery provides electric power to the electric motor and the backup battery does not provide electric power to the electric motor. When the switch is operating in a second state, the backup battery provides power to the electric motor and the primary battery does not provide electric power to the electric motor. The system, via processing of the battery status information of the primary battery, determines a failure of the primary battery. The system, responsive to determining the failure of the primary battery, adjusts the switch from the first state to the second state.

### CROSS REFERENCE TO RELATED APPLICATION

The present application claims the filing benefits of U.S. provisional application Ser. No. 63/377,391, filed Sep. 28, 2022, which is hereby incorporated herein by reference in its entirety.

### FIELD OF THE INVENTION

The present invention relates generally to a vehicle control system for an electric vehicle.

### BACKGROUND OF THE INVENTION

Use of batteries to power electric motors in vehicles is common and known.

### SUMMARY OF THE INVENTION

A vehicular control system includes an electric motor operable to, when powered, drive one or more wheels of a vehicle equipped with the vehicular control system. The system includes a primary battery operable to provide electric power to the electric motor and a backup battery operable to provide electric power to the electric motor. The system also includes a switch that is operable in a first state and that is operable in a second state. When the switch is operating in the first state, the primary battery provides electric power to the electric motor and the backup battery does not provide electric power to the electric motor. When the switch is operating in the second state, the backup battery provides power to the electric motor and the primary battery does not provide electric power to the electric motor. The system includes an electronic control unit (ECU) including electronic circuitry and associated software. Battery status information of the primary battery is provided to and processed at the ECU. The vehicular control system, with the switch operating in the first state and responsive to processing at the ECU of the battery status information of the primary battery, determines a failure condition of the primary battery. The vehicular control system, responsive to determining the failure condition of the primary battery, adjusts the switch from operating in the first state to operating in the second state.

These and other objects, advantages, purposes and features of the present invention will become apparent upon review of the following specification in conjunction with the drawings.

### BRIEF DESCRIPTION OF THE DRAWINGS

FIG. 1 is a plan view of an electric vehicle with a control system that incorporates a primary battery and a backup battery; and

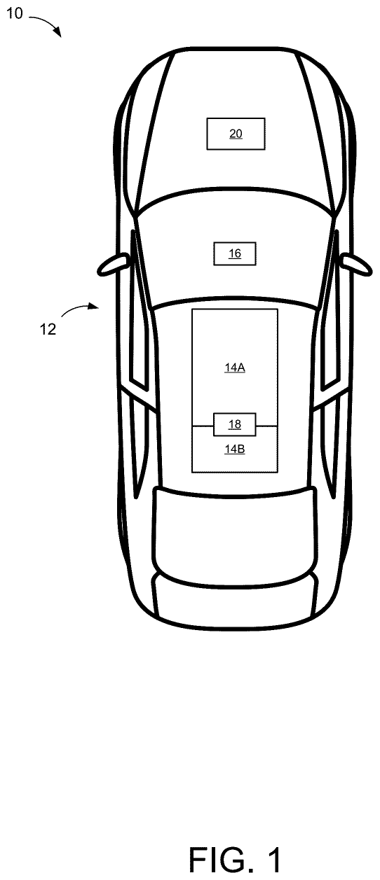

FIG. 2 is a block diagram of the control system of FIG. 1.

### DESCRIPTION OF THE PREFERRED EMBODIMENTS

A vehicular control system operates to manage and/or control a power charging and distribution system of an electric vehicle. The system includes a primary battery and a backup battery. The system monitors for failures of the primary battery or battery controller, and in the case of such a failure, switches power to one or more electric motors of the vehicle from the primary battery to the backup battery.

Referring now to the drawings and the illustrative embodiments depicted therein, a vehicle 10 includes a control system 12 that includes a primary battery 14A and a backup battery 14B. A battery monitoring system (BMS) 16 includes a processor or controller (such as an electronic control unit (ECU)) that monitors and controls the primary battery 14A (i.e., controls the charging and discharging of the primary battery 14A). The primary battery 14A, under normal operating conditions, provides electric power to one or more electric motors 20 of the vehicle 10. When the BMS 16 detects a failure of the primary battery 14A such that the primary battery 14A is no longer capable of providing adequate power to the electric motor 20 (i.e., the electric vehicle is no longer able to maneuver using power from the primary battery 14A), the BMS 16 may operate a switch 18 to instead provide power to the electric motor 20 via the backup battery 14B. The BMS 14 may communicate with the batteries 14A, 14B, the switch 18, the electric motor(s) 20, and/or any other sensors via any suitable data or communication link, such as a vehicle network bus or the like of the equipped vehicle.

In conventional electric autonomous or semi-autonomous vehicles, the battery pack represents a single point of failure for maneuvering the vehicle. For example, the electric motor(s) receive power from the battery pack, and in the event of a catastrophic battery failure where the battery is no longer capable of providing sufficient power, the motors will not function and the wheels cannot be driven by the motor(s). In many scenarios, such an event will be dangerous to the occupants and the vehicle, as the vehicle will be unable to maneuver through traffic to come to a safe stop. For L3 semi-autonomous systems, this single point of failure may be accounted for during system handover (i.e., returning control to the driver) and L4+ autonomous vehicles should provide true redundancy to reach acceptable mean time between failures (MTBF) rates.

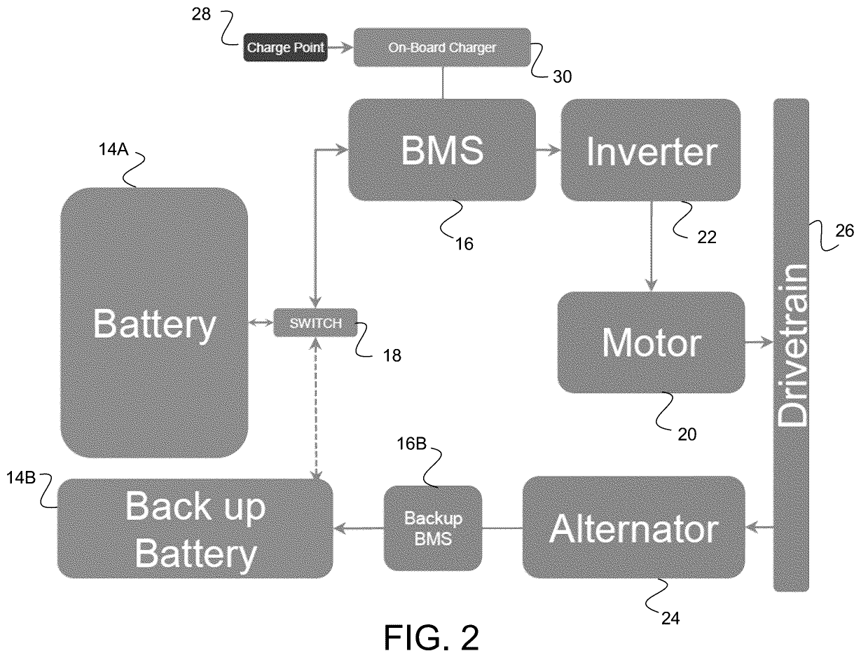

Implementations herein include a vehicular control system that includes a “limp home mode” to support short range maneuvers in case of failure of a main or primary battery in an electric vehicle. Referring now to FIG. 2, the system includes the primary battery 14A and the backup battery 14B. The BMS 16 controls charging/discharging the primary battery 14A (e.g., via a charge point 28 and an on-board charger 30) and providing power to an inverter 22 from the primary battery 14 that in turn supplies power to the electric motor 20. The electric motor 20 then moves the vehicle via mechanical energy delivered to a drivetrain 26 of the vehicle.

The system includes the switch 18 that the BMS 16 may control to select which battery 14A, 14B provides power to the motor 20. The switch 18 includes two states. In a first state, the switch allows the primary battery 14A to provide power to the motor 20 and may not allow the backup battery 14B to provide power to the motor 20. In the second state, the switch allows the backup battery 14B to provide power to the motor 20 (and may also prohibit the primary battery 14A from providing power to the motor 20). During normal operation, the switch 18 allows the primary battery 14A to power the motor 20. During a failure event or other scenario where the primary battery 14A cannot provide adequate power to the motor 20, the BMS 16 may actuate the switch 18 to instead allow the backup battery 14B to power the motor 20. The switch 18 may be any type of electrical switch. For example, the switch 18 may include bipolar transistors, a power diode, MOSFET transistors, a silicon controlled rectifier, etc. The switch may bypass the primary battery 14A and allow the backup battery 14B to provide power to the motor 20 via the same inverter 22 as used by the primary battery 14A. In other examples, power from the backup battery 14B is provided to the motor 20 using a backup inverter.

The backup battery 14B may be charged via the charge point 28 and the on-board charger 30 after the main battery 14a is fully charged and/or during normal driving through an alternator 24 (e.g., a lossless alternator). That is, in some examples, the primary battery 14A has priority in charging versus the backup battery 14B. In other examples, the backup battery 14B has priority in charging over the primary battery 14A. In yet other examples, both batteries 14A, 14B are charged (at reduced rates) simultaneously. The system may include a backup BMS 16B which is only used during normal driving conditions (i.e., when the primary battery 14A is providing power to the motor 20) to charge the backup battery 14B (e.g., via the alternator 24).

The backup battery 14B may provide sufficient power to the motor 20 to allow the vehicle and/or the driver to maneuver the vehicle to a safe location (e.g., at least 5 seconds or at least 10 seconds or at least 20 seconds of power). In some examples, the backup battery 14B may allow the vehicle to travel some distance at a reduced or limited speed (e.g., at least 1 mile, at least 5 miles, or at least 10 miles at 30 to 40 miles per hour). The backup battery 14B may provide power to any number of other ancillary systems as well (e.g., sensors, processing systems, steering/braking controls, etc.). The system may monitor any health information (i.e., battery status information) reported from the primary battery 14A in preparation for takeover or handover from the primary battery 14A to the backup battery 14B. For example, the health information may indicate that the battery can no longer provide sufficient power or that the battery's temperature is not within safe parameters or the like. In some examples, the switch 18 functions as an OR gate that immediately allows power from the backup battery 14B to power the motors in the event that the primary battery 14A fails to provide adequate power.

The system may provide a suitable alert or notification to the occupants of the vehicle when a handover event occurs or is about to occur. The alert may include an indication of remaining capacity of the backup battery 14B (i.e., an amount of time and/or a distance until the backup battery 14B will be out of power). The alert may include a visual alert displayed on one or more display screens disposed within the vehicle and/or an audible alert played over speakers disposed within the vehicle. When operating on the backup battery 14B, the system may restrict the use of various features of the vehicle to save power. For example, use of heating and/or air conditioning, an infotainment system, etc., may be limited. Speed and/or acceleration of the vehicle may be limited or reduced while operating on the backup battery 14B. Generally, the backup battery 14B has a smaller capacity than the primary battery 14A, however the backup battery 14B may include any amount of capacity relative to the primary battery 14A.

For autonomous vehicles suitable for deployment with the system, an occupant of the vehicle may, under particular circumstances, be desired or required to take over operation/control of the vehicle and drive the vehicle so as to avoid potential hazard for as long as the autonomous system relinquishes such control or driving. Such an occupant of the vehicle thus becomes the driver of the autonomous vehicle. As used herein, the term “driver” refers to such an occupant, even when that occupant is not actually driving the vehicle, but is situated in the vehicle so as to be able to take over control and function as the driver of the vehicle when the vehicle control system hands over control to the occupant or driver or when the vehicle control system is not operating in an autonomous or semi-autonomous mode.

Typically an autonomous vehicle would be equipped with a suite of sensors, including multiple machine vision cameras deployed at the front, sides and rear of the vehicle, multiple radar sensors deployed at the front, sides and rear of the vehicle, and/or multiple lidar sensors deployed at the front, sides and rear of the vehicle. Typically, such an autonomous vehicle will also have wireless two way communication with other vehicles or infrastructure, such as via a car2car (V2V) or car2x communication system.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular control system, the vehicular control system comprising:
an electric motor operable to, when powered, drive one or more wheels of a vehicle equipped with the vehicular control system;
a primary battery operable to provide electric power to the electric motor;
a backup battery operable to provide electric power to the electric motor;
a switch that is operable in a first state and that is operable in a second state, wherein, when the switch is operating in the first state, the primary battery provides electric power to the electric motor and the backup battery does not provide electric power to the electric motor, and wherein, when the switch is operating in the second state, the backup battery provides power to the electric motor and the primary battery does not provide electric power to the electric motor;
an electronic control unit (ECU) comprising electronic circuitry and associated software;
wherein battery status information of the primary battery is provided to and processed at the ECU;
wherein the vehicular control system, with the switch operating in the first state and responsive to processing at the ECU of the battery status information of the primary battery, determines a failure condition of the primary battery; and
wherein the vehicular control system, responsive to determining the failure condition of the primary battery, adjusts the switch from operating in the first state to operating in the second state.

2. The vehicular control system of claim 1, wherein the vehicular control system, when the vehicle is charging at a charge point, determines the primary battery is fully charged, and wherein the vehicular control system, responsive to determining that the primary battery is fully charged, charges the backup battery.

3. The vehicular control system of claim 1, further comprising an alternator, wherein the vehicular control system, when the primary battery is providing electric power to the electric motor, charges the backup battery via the alternator.

4. The vehicular control system of claim 3, wherein the alternator comprises a lossless alternator.

5. The vehicular control system of claim 3, wherein a backup battery management system charges the backup battery.

6. The vehicular control system of claim 5, wherein the backup battery management system only charges the backup battery when the switch is operating in the first state.

7. The vehicular control system of claim 1, wherein the backup battery, after the vehicular control system adjusts the switch from operating in the first state to operating in the second state, provides electric power to the electric motor for at least ten seconds.

8. The vehicular control system of claim 1, wherein the vehicular control system comprises an inverter, and wherein the inverter, with the switch operating in the first state, changes direct current provided by the primary battery to alternating current for the electric motor, and wherein the inverter, with the switch operating in the second state, changes direct current provided by the backup battery to alternating current for the electric motor.

9. The vehicular control system of claim 1, wherein the switch comprises an electrical switch.

10. The vehicular control system of claim 1, wherein the vehicular control system, responsive to determining the failure condition of the primary battery, generates an alert for an occupant of the vehicle.

11. The vehicular control system of claim 10, wherein the alert comprises a remaining capacity of the backup battery.

12. The vehicular control system of claim 1, wherein the battery status information comprises health information for the primary battery.

13. A vehicular control system, the vehicular control system comprising:
an electric motor operable to, when powered, drive one or more wheels of a vehicle equipped with the vehicular control system;
a primary battery operable to provide electric power to the electric motor;
a backup battery operable to provide electric power to the electric motor;
an electrical switch that is operable in a first state and that is operable in a second state, wherein, when the electrical switch is operating in the first state, the primary battery provides electric power to the electric motor and the backup battery does not provide electric power to the electric motor, and wherein, when the electrical switch is operating in the second state, the backup battery provides power to the electric motor and the primary battery does not provide electric power to the electric motor;
an electronic control unit (ECU) comprising electronic circuitry and associated software;
wherein battery status information of the primary battery is provided to and processed at the ECU;
wherein the vehicular control system, with the electrical switch operating in the first state and responsive to processing at the ECU of the battery status information of the primary battery, determines a failure condition of the primary battery;
wherein the vehicular control system comprises an inverter, and wherein the inverter, with the electrical switch operating in the first state, changes direct current provided by the primary battery to alternating current for the electric motor, and wherein the inverter, with the electrical switch operating in the second state, changes direct current provided by the backup battery to alternating current for the electric motor; and
wherein the vehicular control system, responsive to determining the failure condition of the primary battery, adjusts the electrical switch from operating in the first state to operating in the second state.

14. The vehicular control system of claim 13, wherein the vehicular control system, when the vehicle is charging at a charge point, determines the primary battery is fully charged, and wherein the vehicular control system, responsive to determining that the primary battery is fully charged, charges the backup battery.

15. The vehicular control system of claim 13, further comprising an alternator, wherein the vehicular control system, when the primary battery is providing electric power to the electric motor, charges the backup battery via the alternator.

16. The vehicular control system of claim 15, wherein the alternator comprises a lossless alternator.

17. The vehicular control system of claim 15, wherein a backup battery management system charges the backup battery.

18. A vehicular control system, the vehicular control system comprising:
an electric motor operable to, when powered, drive one or more wheels of a vehicle equipped with the vehicular control system;
a primary battery operable to provide electric power to the electric motor;
a backup battery operable to provide electric power to the electric motor;
a switch that is operable in a first state and that is operable in a second state, wherein, when the switch is operating in the first state, the primary battery provides electric power to the electric motor and the backup battery does not provide electric power to the electric motor, and wherein, when the switch is operating in the second state, the backup battery provides power to the electric motor and the primary battery does not provide electric power to the electric motor;
an electronic control unit (ECU) comprising electronic circuitry and associated software;
wherein battery status information of the primary battery is provided to and processed at the ECU;
wherein the vehicular control system, with the switch operating in the first state and responsive to processing at the ECU of the battery status information of the primary battery, determines a failure condition of the primary battery;
wherein the vehicular control system, responsive to determining the failure condition of the primary battery, adjusts the switch from operating in the first state to operating in the second state;
wherein the backup battery, after the vehicular control system adjusts the switch from operating in the first state to operating in the second state, provides electric power to the electric motor for at least ten seconds; and
wherein the vehicular control system, responsive to determining the failure condition of the primary battery, generates an alert for an occupant of the vehicle.

19. The vehicular control system of claim 18, wherein the alert comprises a remaining capacity of the backup battery.

20. The vehicular control system of claim 19, wherein the battery status information comprises health information for the primary battery.
